(19) United States
(12) Patent Application Publication
(10) Pub. No.: US 2021/0313578 A1
(43) Pub. Date: Oct. 7, 2021

(54) METHOD AND SYSTEM FOR CLAY MINERALS AS CATHODE, SILICON ANODE, OR SEPARATOR ADDITIVES IN LITHIUM-ION BATTERIES

(71) Applicant: Enevate Corporation, Irvine, CA (US)

(72) Inventors: Liwen Ji, San Diego, CA (US); Sanjaya D. Perera, Irvine, CA (US); Benjamin Park, Mission Viejo, CA (US)

(21) Appl. No.: 16/837,807

(22) Filed: Apr. 1, 2020

(51) Int. Cl. H01M 4/62; H01M 4/134; H01M 4/38; H01M 10/0525; H01M 10/058

(52) U.S. Cl. CPC H01M 4/62; H01M 4/134; H01M 4/131; H01M 10/0525; H01M 10/058; H01M 4/386

(57) ABSTRACT

Systems and methods for clay minerals as cathode, silicon anode, or separator additives in lithium-ion batteries may include an anode, an electrolyte, and a cathode, where the cathode comprises an active material and a clay additive. The active material may include one or more of nickel cobalt aluminum oxide (NCA), nickel cobalt manganese oxide (NCM), NCMA, lithium iron phosphate (LFP), lithium cobalt oxide (LCO), and lithium manganese oxide (LMO), Ni-rich layered oxides LiNi₁₋ₓMₓO₂ where M=Co, Mn, or Al, Li-rich xLi₂MnO₃(1−x)LiNiₐCo_{b}Mn_{c}O₂, Li-rich layered oxides LiNi₁₊ₓM₁₋ₓO₂ where M=Co, Mn, or Ni, and spinel oxides LiNi_{0.5}Mn_{1.5}O₄. The clay additive may include a Kaolin group clay mineral, where the Kaolin group clay mineral includes Kaolinite or Halloysite. The clay additive may comprise one or more of a Smectite group clay mineral, an Illite group clay mineral, and a Chlorite group clay material. The anode may include graphite and/or graphene.

### CROSS-REFERENCE TO RELATED APPLICATIONS/INCORPORATION BY REFERENCE

N/A

### FIELD

Aspects of the present disclosure relate to energy generation and storage. More specifically, certain embodiments of the disclosure relate to a method and system for clay minerals as cathode, silicon anode, or separator additives in lithium-ion batteries.

### BACKGROUND

Conventional approaches for battery electrodes may be costly, cumbersome, and/or inefficient—e.g., they may be complex and/or time consuming to implement, and may limit battery lifetime.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

A system and/or method for clay minerals as cathode, silicon anode, or separator additives in lithium-ion batteries, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 is a diagram of a battery, in accordance with an example embodiment of the disclosure.

FIG. 2 is a flow diagram of a direct coating process for forming a cell with clay additives, in accordance with an example embodiment of the disclosure.

FIG. 3 is a flow diagram of an alternative process for lamination of electrodes, in accordance with an example embodiment of the disclosure.

FIG. 4 illustrates molecular structures of kaolinite and halloysite that may be utilized in cathodes, silicon-dominant anodes, or separators, in accordance with an example embodiment of the disclosure.

FIG. 5 illustrates cyclic voltammetry curves for cells with control cathodes and cathodes with clay additives, in accordance with an example embodiment of the disclosure.

FIGS. 6A-6B illustrates capacity retention plots for cells with NCM811 vs. NCM811 cathodes with a clay additive, in accordance with an example embodiment of the disclosure.

FIG. 7 illustrates cyclic voltammetry curves for control cathodes and for cathodes with clay additives, in accordance with an example embodiment of the disclosure.

FIGS. 8A-8B illustrate capacity retention plots for cells with NCM811 vs. NCM811 cathodes with a clay additive, in accordance with an example embodiment of the disclosure.

### DETAILED DESCRIPTION OF THE INVENTION

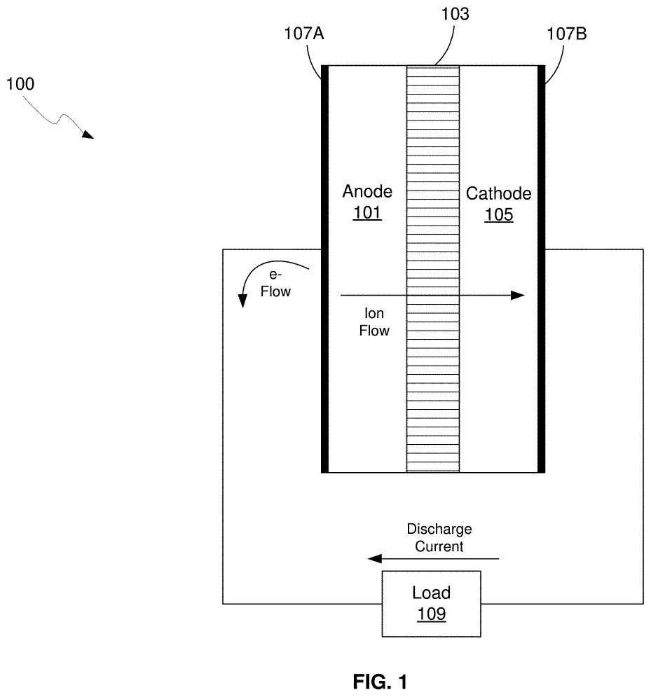

FIG. 1 is a diagram of a battery, in accordance with an example embodiment of the disclosure. Referring to FIG. 1, there is shown a battery 100 comprising a separator 103 sandwiched between an anode 101 and a cathode 105, with current collectors 107A and 107B. There is also shown a load 109 coupled to the battery 100 illustrating instances when the battery 100 is in discharge mode. In this disclosure, the term “battery” may be used to indicate a single electrochemical cell, a plurality of electrochemical cells formed into a module, and/or a plurality of modules formed into a pack.

The development of portable electronic devices and electrification of transportation drive the need for high performance electrochemical energy storage. Small-scale (<100 Wh) to large-scale (>10 KWh) devices primarily use lithium-ion (Li-ion) batteries over other rechargeable battery chemistries due to their high-performance.

The anode 101 and cathode 105, along with the current collectors 107A and 107B, may comprise the electrodes, which may comprise plates or films within, or containing, an electrolyte material, where the plates may provide a physical barrier for containing the electrolyte as well as a conductive contact to external structures. In other embodiments, the anode/cathode plates are immersed in electrolyte while an outer casing provides electrolyte containment. The anode 101 and cathode are electrically coupled to the current collectors 107A and 1078, which comprise metal or other conductive material for providing electrical contact to the electrodes as well as physical support for the active material in forming electrodes.

The configuration shown in FIG. 1 illustrates the battery 100 in discharge mode, whereas in a charging configuration, the load 107 may be replaced with a charger to reverse the process. In one class of batteries, the separator 103 is generally a film material, made of an electrically insulating polymer, for example, that prevents electrons from flowing from anode 101 to cathode 105, or vice versa, while being porous enough to allow ions to pass through the separator 103. Typically, the separator 103, cathode 105, and anode 101 materials are individually formed into sheets, films, or active material coated foils. Sheets of the cathode, separator and anode are subsequently stacked or rolled with the separator 103 separating the cathode 105 and anode 101 to form the battery 100. In some embodiments, the separator 103 is a sheet and generally utilizes winding methods and stacking in its manufacture. In these methods, the anodes, cathodes, and current collectors (e.g., electrodes) may comprise films.

In an example scenario, the battery 100 may comprise a solid, liquid, or gel electrolyte. The separator 103 preferably does not dissolve in typical battery electrolytes such as compositions that may comprise: Ethylene Carbonate (EC), Fluoroethylene Carbonate (FEC), di-fluoroethylene carbonate (DiFEC), trifluoropropylene carbonate (TFPC), vinyl carbonate (VC), Propylene Carbonate (PC), Dimethyl Carbonate (DMC), Ethyl Methyl Carbonate (EMC), Diethyl Carbonate (DEC), etc. with dissolved lithium hexafluorophosphate (LiPF₆), lithium tetrafluoroborate (LiBF₄), lithium hexafluoroarsenate monohydrate (LiAsF₆), lithium perchlorate (LiClO₄), lithium bis(trifluoromethanesulfonyl)imide (LiTFSI), lithium bis(fluorosulfonyl)imide (LiFSI), lithium difluoro(oxalate)borate (LiDFOB), lithium bis(oxalato)borate (LiBOB), and lithium triflate (LiCF₃SO₃), lithium tetrafluorooxalato phosphate (LTFOP), lithium difluorophosphate (LiPO₂F₂), lithium pentafluoroethyltrifluoroborate (LiFAB), and lithium 2-trifluoromethyl-4,5-dicyanoimidazole (LiTDI), lithium bis(2-fluoromalonato)borate (LiBFMB), lithium 4-pyridyl trimethyl borate (LPTB) and lithium 2-fluorophenol trimethyl borate (LFPTB), lithium catechol dimethyl borate (LiCDMB), etc.

The separator 103 may be wet or soaked with a liquid or gel electrolyte. In addition, in an example embodiment, the separator 103 does not melt below about 100 to 120° C., and exhibits sufficient mechanical properties for battery applications. A battery, in operation, can experience expansion and contraction of the anode and/or the cathode. In an example embodiment, the separator 103 can expand and contract by at least about 5 to 10% without failing, and may also be flexible.

The separator 103 may be sufficiently porous so that ions can pass through the separator once wet with, for example, a liquid or gel electrolyte. Alternatively (or additionally), the separator may absorb the electrolyte through a gelling or other process even without significant porosity. The porosity of the separator 103 is also generally not too porous to allow the anode 101 and cathode 105 to transfer electrons through the separator 103.

The anode 101 and cathode 105 comprise electrodes for the battery 100, providing electrical connections to the device for transfer of electrical charge in charge and discharge states. The anode 101 may comprise silicon, carbon, or combinations of these materials, for example. Typical anode electrodes comprise a carbon material that includes a current collector such as a copper sheet. Carbon is often used because it has excellent electrochemical properties and is also electrically conductive. Anode electrodes currently used in rechargeable lithium-ion cells typically have a specific capacity of approximately 200 milliamp hours per gram. Graphite, the active material used in most lithium ion battery anodes, has a theoretical energy density of 372 milliamp hours per gram (mAh/g). In comparison, silicon has a high theoretical capacity of 4200 mAh/g at high temperature and 3579 mAh/g at room temperature. In order to increase volumetric and gravimetric energy density of lithium-ion batteries, silicon may be used as the active material for the cathode or anode. Silicon anodes may be formed from silicon composites, with more than 50% silicon, for example.

In an example scenario, the anode 101 and cathode 105 store the ion used for separation of charge, such as lithium. In this example, the electrolyte carries positively charged lithium ions from the anode 101 to the cathode 105 in discharge mode, as shown in FIG. 1 for example, and vice versa through the separator 105 in charge mode. The movement of the lithium ions creates free electrons in the anode 101 which creates a charge at the positive current collector 1078. The electrical current then flows from the current collector through the load 109 to the negative current collector 107A. The separator 103 blocks the flow of electrons inside the battery 100, allows the flow of lithium ions, and prevents direct contact between the electrodes.

While the battery 100 is discharging and providing an electric current, the anode 101 releases lithium ions to the cathode 105 via the separator 103, generating a flow of electrons from one side to the other via the coupled load 109. When the battery is being charged, the opposite happens where lithium ions are released by the cathode 105 and received by the anode 101.

The materials selected for the anode 101 and cathode 105 are important for the reliability and energy density possible for the battery 100. The energy, power, cost, and safety of current Li-ion batteries need to be improved in order to, for example, compete with internal combustion engine (ICE) technology and allow for the widespread adoption of electric vehicles (EVs). High energy density, high power density, and improved safety of lithium-ion batteries are achieved with the development of high-capacity and high-voltage cathodes, high-capacity anodes and functionally non-flammable electrolytes with high voltage stability and interfacial compatibility with electrodes. In addition, materials with low toxicity are beneficial as battery materials to reduce process cost and promote consumer safety.

The performance of electrochemical electrodes, while dependent on many factors, is largely dependent on the robustness of electrical contact between electrode particles, as well as between the current collector and the electrode particles. The electrical conductivity of silicon anode electrodes may be manipulated by incorporating conductive additives with different morphological properties. Carbon black (SuperP), vapor grown carbon fibers (VGCF), graphite, graphene, etc., and/or a mixture of these have previously been incorporated separately into the anode electrode resulting in improved performance of the anode. The synergistic interactions between the two carbon materials may facilitate electrical contact throughout the large volume changes of the silicon anode during charge and discharge.

State-of-the-art lithium-ion batteries typically employ a graphite-dominant anode as an intercalation material for lithium. Silicon-dominant anodes, however, offer improvements compared to graphite-dominant Li-ion batteries. Silicon exhibits both higher gravimetric (3579 mAh/g vs. 372 mAh/g for graphite) and volumetric capacities (2194 mAh/L vs. 890 mAh/L for graphite). In addition, silicon-based anodes have a lithiation/delithiation voltage plateau at about 0.3-0.4V vs. Li/Li⁺, which allows it to maintain an open circuit potential that avoids undesirable Li plating and dendrite formation. While silicon shows excellent electrochemical activity, achieving a stable cycle life for silicon-based anodes is challenging due to silicon's large volume changes during lithiation and delithiation. Silicon regions may lose electrical contact from the anode as large volume changes coupled with its low electrical conductivity separate the silicon from surrounding materials in the anode.

In addition, the large silicon volume changes exacerbate solid electrolyte interphase (SEI) formation, which can further lead to electrical isolation and, thus, capacity loss. Expansion and shrinkage of silicon particles upon charge-discharge cycling causes pulverization of silicon particles, which increases their specific surface area. As the silicon surface area changes and increases during cycling, SEI repeatedly breaks apart and reforms. The SEI thus continually builds up around the pulverizing silicon regions during cycling into a thick electronic and ionic insulating layer. This accumulating SEI increases the impedance of the electrode and reduces the electrode electrochemical reactivity, which is detrimental to cycle life.

Among all the potential cathode active materials, Ni-rich NCA (Nickel cobalt aluminum oxide) and NCM (Nickel Cobalt Manganese Oxide) are considered to be most promising. Ni-rich NCA or NCM cathodes show excellent thermodynamic stability and specific capacity as high as 200 mAh/g. Although NCA or NCM are best known for long-term stability and high energy density, they have also been shown to be problematic due to poor cycle stability and low electronic conductivity.

It is generally believed that the capacity of the cathode materials is one of the major limiting factors for the energy density of Li-ion batteries. Therefore, Ni-rich cathode materials (such as NCA, NCM) and Li-rich layered oxide cathode materials have been considered and explored as the possible future choices because of their high specific capacity and low cost. These materials are especially useful if they can be coupled with high capacity and low-voltage anode materials, such as Si. However, these cathode materials have some fundamental challenges, such as irreversible phase transition from hexagonal through cubic to rock salt structure, mechanical cracking of the secondary particle structure, electrolyte depletion that is often accompanied by impedance increase and volumetric swelling of the batteries, as well as gelation of cathode slurry in the slurry-making process.

From the cathode side, a number of strategies may be utilized to overcome these issues, such as cation doping for stabilizing the cathode material lattice structure, surface coating for protecting cathode particles from parasitic reactions with the electrolyte components, synthesizing concentration-gradient or core-shell structures with high Ni content core for stabilizing the material's surface chemistry, as well as using electrolyte additives for chemically trapping released oxygen.

Without negative impacts on the anode, electrolyte, and the battery manufacturing procedures or design, incorporating a cathode additive is an efficient, cost-effective and practically feasible strategy to overcome the issues with layered cathode materials and to improve the full cell performance.

Commercial Li-ion batteries are based on graphite anode layered metal oxide cathodes, particularly Ni-rich LiMO₂ (M—Ni, Co, Mn). Layered Li[NiₓCo_{y}(Al or Mn)_{1-x-y}]O₂ (Al=NCA or Mn=NCM) materials have been the most promising cathode materials used for EVs, as evidenced by an automobile manufacturer adopting an NCA cathode, Li[Ni_{0.8}Co_{0.15}Al_{0.05}]O₂ (NCM811), in its current model cars. High Ni content cathodes (NCM and NCA) that can provide high capacity (180-200 mAh/g) have become the fastest developing commercial cathode for EVs in recent years. However, their thermal instability on de-lithiation due to the presence of the high-valance Ni raises safety concerns for Li-ion cells. These cathodes also have some issues with metal dissolution which this disclosure addresses/solves. Compared to Ni-rich cathodes, olivine LiFePO₄ electrodes are significantly more stable to lithium extraction, but their low capacities (100-150 mAh/g) limit their use in EVs.

In addition, the nominal upper cutoff voltage of layered structures is ˜4.0-4.2 V. An increase in the upper cutoff voltage of such materials results in the higher capacity fade of the cathode. Thus, new and improved cathode materials with modified chemical compositions or novel additives that can suppress inherent instability of layered Ni-rich cathode materials are desired to meet the ever-growing demand for high energy density, long cycle life, and cost-effective Li-ion batteries.

Although Ni-rich NCM or NCA are promising cathode materials for high energy density Li-ion batteries because of their high capacity and low cost, charging the NCM or NCA cathode to high potentials not only triggers oxygen evolution but also causes oxidative decomposition of the electrolyte solvents which finally lead to serious capacity degradation. To overcome these problems, a number of strategies may be utilized, including cationic doping for stabilizing the lattice structure, surface coating for protecting particles from reacting with the electrolyte components, synthesizing concentration-gradients, core-shell materials with high Ni content core, and using electrolyte additives, for example.

The surface modification of a cathode active material can greatly affect battery performance because the electrochemical reaction takes place at the interface of the electrochemically active materials and the electrolyte. The protective effects of these surface coatings are typically attributed to the scavenging of HF, limiting transition metal dissolution, altering the composition of the solid electrolyte interface on the positive electrode, and the physical blockage of electrolyte components from reaching the electroactive material surface. However, these treatments need additional precipitating (or washing) and heating processes, leading to an increase in the cost of battery manufacture.

In order to simplify the treatment process, in this disclosure a small amount of clay minerals is dispersed into the normal cathode-coating slurry to prepare clay mineral-containing cathodes for Si-dominant anode-based Li-ion batteries. Clay is a finely-grained natural rock or soil material that combines one or more clay minerals with possible traces of quartz (SiO₂), metal oxides (Al₂O₃, MgO, etc.) and organic matter. The presence of the clay minerals may provide the following benefits: (i) serves as a chemically stable and mechanically strong interphase, which minimizes the reductive reaction of carbonate electrolytes and other solvents, and suppresses the direct contact between cathode electrodes or cathode powders and other solvents, and therefore may enhance electrochemical stability; (ii) helps modify the cathode electrolyte interphase (CEI) layer composition and improve the CEI stability on the surface of cathodes or cathode powders, which permits effective surface passivation of the cathode, increase CEI robustness and structural stability of the cathodes; (iii) helps reduce the impedance built-up throughout cycling; (iv) helps reduce the dissolution of transition metal ions from the cathode side; (v) consumes HF using the containing metal oxide; (vi) acts as a rheology additive in the electrode coating slurry and as a lithium-ion conducting additive, (vii) depresses the severe aggregation of cathode powders, and (viii) helps improve the thermal stability. Therefore, the presence of clay minerals provides substantial benefits to Li-ion battery cathodes and contributes to electrochemical performance improvements.

In an example embodiment, Kaolin group minerals, which include dickite, nacrite, kaolinite and halloysite, and the trioctahedral minerals antigorite, chamosite, chrysotile, and cronstedite may be used as cathode additives for NCM811 cathode-based Li-ion full cells. Kaolinite is a clay mineral, part of the group of industrial minerals with the chemical composition Al₂Si₂O₆(OH)₄. It is a layered silicate mineral, with one tetrahedral sheet of silica (SiO₄) linked through oxygen atoms to one octahedral sheet of alumina (AlO₆) octahedral. The primary structural unit of the Kaolin group is a layer composed of one octahedral sheet condensed with one tetrahedral sheet. In the dioctahedral minerals the octahedral site are occupied by aluminum; in the trioctahedral minerals these sites are occupied by magnesium and iron. Kaolinite and halloysite comprise single-layer structures.

In another example scenario, Kaoline-serpentine group clay minerals may be utilized as cathode additives for NCM811 cathodes-based Li-ion full cells. These materials form hydrous magnesium iron phyllosilicate ((Mg,Fe)₃Si₂O₅(OH)₄) minerals.

In yet another example, the following materials may be utilized as cathode additives in NCM cathode-based cells: 1) smectite group clay minerals, which include dioctahedral smectites such as montmorillonite, nontronite and nicbeidellite, and trioctahedral smectites such as saponite; 2) the Illite group clay mineral, which includes clay-micas; 3) chlorite group clay minerals, which include a wide variety of similar minerals with considerable chemical variation; 4) other 2:1 clay types such as sepiolite or attapulgite.

These materials may be utilized as cathode additives for NCM811 or other NCM cathodes-based Li-ion full cells, such as NCM9 0.5 0.5, NCM622, NCM532, NCM433, NCM442, NCM111, NCMA, and others. Furthermore, the additives disclosed here may be utilized in NCA, LCO, LMO, Li-rich xLi₂MnO₃.(1−x)LiNiₐCo_{b}Mn_{c}O₂, (LiNi₁₋ₓMₓO₂, Mn=Co, Mn, and Al), Li-rich layered oxides (LiNi₁₊ₓM₁₋ₓO₂, Mn=Co, Mn, and Ni), high-voltage spinel oxides (LiNi_{0.5}Mn_{1.5}O₄), high-voltage polyanionic compounds (phosphates, sulfates, silicates, etc.) cathode-based Li-ion full cells.

Furthermore, these clay minerals may be utilized as additives in Si-dominant anode-based Li-ion full cells with different cathodes, and may comprise direct coated Si-dominant anodes or other Si anode-based Li-ion full cells with different cathodes. Finally, the clay minerals may be utilized to modify separators to prepare different types of functional separators for Li-ion batteries and Li-metal batteries.

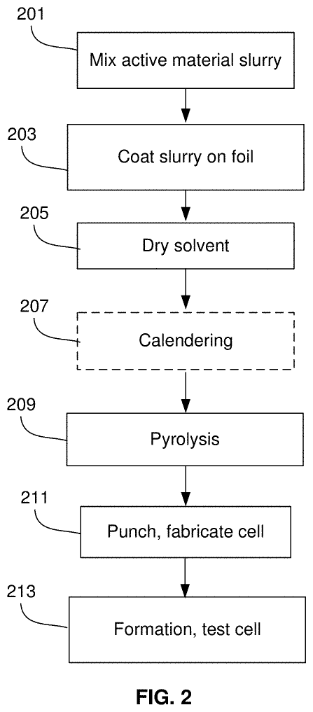

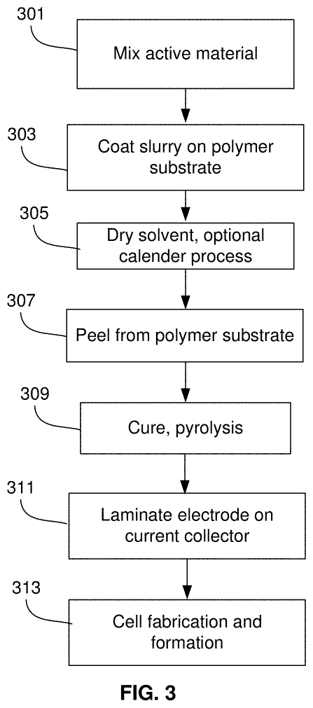

FIG. 2 is a flow diagram of a direct coating process for forming a cell with a clay additive cathode, in accordance with an example embodiment of the disclosure. This process comprises physically mixing the active material, conductive additive, and binder together, and coating it directly on a current collector. This example process comprises a direct coating process in which a slurry is directly coated on a metal foil for fabricating an anode or cathode using a binder such as PVDF, CMC, SBR, Sodium Alginate, PAI, Poly(acrylic acid) (PAA), PI, LA133, polyvinyl alcohol (PVA), polyethylene glycol (PEG), Nafion solution, Cellulose, Guar gum, Alginates, Chitosan, Pullulan, recently reported electronically conductive polymer binders, and mixtures and combinations thereof. Another example process comprising forming the active material on a substrate and then transferring to the current collector is described with respect to FIG. 3.

In step 201, the raw electrode active material may be mixed using a binder/resin (such as PI, PAI), solvent, and conductive carbon. For example, for the cathode, Super P/VGCF (1:1 by weight), or other types carbon materials, such as graphite, graphene, carbon nanotube, etc., may be dispersed in binder solution (mixture of NMP and PVDF) for 0.5 to 2 minutes at 1500-2500 rpm. NCA cathode material powder may be added to the mixture along with NMP solvent, then dispersed for another 1-3 minutes at 1500-2500 rpm to achieve a slurry viscosity within 2000-4000 cP (total solid content of about 48%). A clay-based additive may be mixed in with the slurry at this point, or may be added at a later stage in the process. A similar process may be utilized to mix the active material slurry for the anode, where a binder/resin, conductive carbon, and silicon may be utilized, for example.

In step 203, a slurry may be coated on a copper foil at a loading of 3-6 mg/cm² (with 13-20% solvent content) for the anode and on an aluminum foil at a loading of, e.g., 15-35 mg/cm² for the cathode. The coated foil may undergo drying in step 205 resulting in less than 13-20% residual solvent content. In another example scenario, a clay-based additive may be incorporated by dipping the coated foil in a solution with the desired additive.

In step 207, an optional calendering process may be utilized where a series of hard pressure rollers may be used to finish the film/substrate into a smoother and denser sheet of material.

In step 209, the active material may be pyrolyzed by heating to 500-1200° C. such that carbon precursors are partially or completely converted into glassy carbon. Pyrolysis can be done either in roll form or after punching in step 211. If done in roll form, the punching is done after the pyrolysis process. The punched electrode may then be sandwiched with a separator and cathode with electrolyte to form a cell. In step 213, the cell may be subjected to a formation process, comprising initial charge and discharge steps to lithiate the anode, with some residual lithium remaining and cell testing to determine performance.

FIG. 3 is a flow diagram of an alternative process for lamination of electrodes, in accordance with an example embodiment of the disclosure. While the previous process to fabricate composite anodes employs a direct coating process, this process physically mixes the active material, conductive additive, and binder together coupled with peeling and lamination processes.

This process is shown in the flow diagram of FIG. 3, starting with step 301 where the raw electrode active material may be mixed using a binder/resin (such as PI, PAI), solvent, and conductive carbon. For example, for the cathode, Super P/VGCF (1:1 by weight) may be dispersed in binder solution (mixture of NMP and PVDF) for 0.5 to 2 minutes at 1500-2500 rpm. NCM, NCA, Li-rich or other cathode material powder may be added to the mixture along with NMP solvent, then dispersed for another 1-3 minutes at 1500-2500 rpm to achieve a slurry viscosity within 2000-4000 cP (total solid content of about 48%). A clay-based additive may be mixed in with the slurry at this point, or may be added at a later stage in the process. A similar process may be utilized to mix the active material slurry for the anode.

In step 303, the slurry may be coated on a polymer substrate, such as polyethylene terephthalate (PET), polypropylene (PP), or Mylar. The slurry may be coated on the PET/PP/Mylar film at a loading of 3-6 mg/cm² (with 13-20% solvent content) for the anode and 15-35 mg/cm² for the cathode, and then dried to remove a portion of the solvent in step 305. In another example scenario, a clay-based additive may be incorporated by dipping the green layer coated substrate in a solution with the desired additive. An optional calendering process may be utilized where a series of hard pressure rollers may be used to finish the film/substrate into a smoothed and denser sheet of material.

In step 307, the green film may then be removed from the PET, where the active material may be peeled off the polymer substrate, the peeling process being optional for a polypropylene (PP) substrate, since PP can leave ˜2% char residue upon pyrolysis. The peeling may be followed by a cure and pyrolysis step 309 where the film may be cut into sheets, and vacuum dried using a two-stage process (100-140° C. for 14-16 hours, 200-240° C. for 4-6 hours). The dry film may be thermally treated at 1000-1300° C. to convert the polymer matrix into carbon.

In step 311, the pyrolyzed material may be flat press or roll press laminated on the current collector, where for aluminum foil for the cathode and copper foil for the anode may be pre-coated with polyamide-imide with a nominal loading of 0.35-0.75 mg/cm² (applied as a 5-7 wt % varnish in NMP, dried 10-20 hour at 100-140° C. under vacuum). In flat press lamination, the active material composite film may be laminated to the coated aluminum or copper using a heated hydraulic press (30-70 seconds, 250-350° C., and 3000-5000 psi), thereby forming the finished composite electrode. In another embodiment, the pyrolyzed material may be roll-press laminated to the current collector. In yet another example scenario, a clay-based additive may be incorporated by dipping the coated foil in a solution with the desired additive.

In step 313, the electrodes may then be sandwiched with a separator and electrolyte to form a cell. The cell may be subjected to a formation process, comprising initial charge and discharge steps to lithiate the anode, with some residual lithium remaining, and testing to assess cell performance.

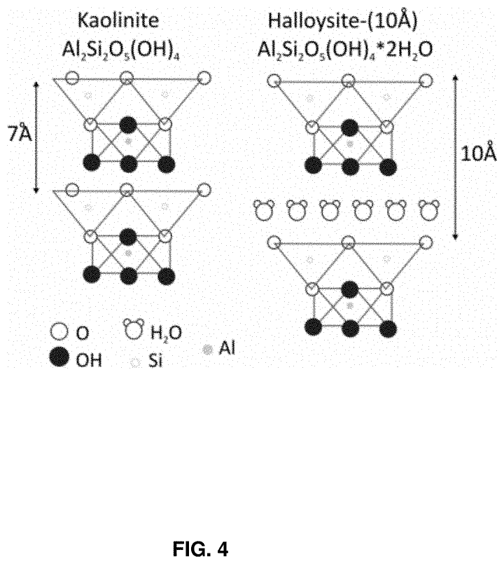

FIG. 4 illustrates molecular structures of kaolinite and halloysite that may be utilized in cathodes, silicon-dominant anodes, or separators, in accordance with an example embodiment of the disclosure. The atomic arrangement and corresponding lattice constants are shown. In an example embodiment of the disclosure, these clay additives may be added to a cathode slurry for the unique electrochemical and physicochemical features of the materials. In a cathode additive scenario, the cathode slurry may be prepared by mixing kaolinite or halloysite into the slurry mixture, with NCM811, for example, for Ni-rich cathode active material and then cast on an aluminum foil and dried to form a cathode electrode. Other kaolin group minerals, in addition to Kaolinite and halloysite, such as dickite, nacrite, and the trioctahedral minerals antigorite, chamosite, chrysotile, and cronstedite may be utilized as as cathode additives for NCM811 cathodes-based Li-ion full cells.

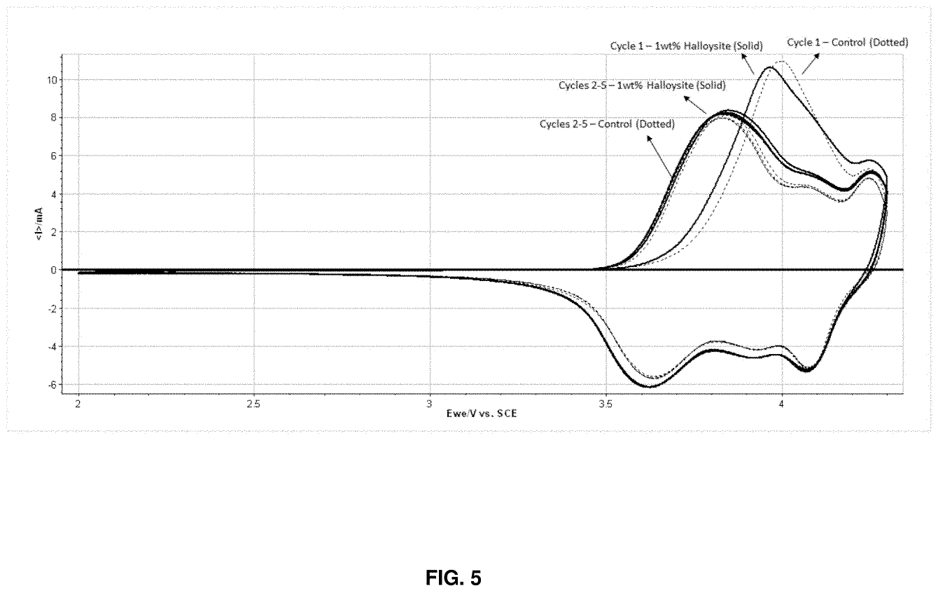

FIG. 5 illustrates cyclic voltammetry curves for control cathodes and for cathodes with clay additives, in accordance with an example embodiment of the disclosure. The plots show the effect of adding 1 wt % Halloysite or Kaolinite into NCM811 cathode slurry as cathode additives to prepare these clay-containing NCM811 cathodes. The Si-dominant anode//NCM811 cathode coin full cells may be tested at 1 C/0.5 C with the voltage window of 4.2V-3.1V at room temperature. The plot shows potentials of the anode and cathode with respect to a saturated calomel electrode at different cell current in milliamps.

In this example, the NCM811 control cathode cell is represented by the dotted lines while the solid lines represent a 1 wt % Halloysite-containing NCM811 cathode cell. The electrolyte formulation used may comprise 1.2 M LiPF₆ in FEC/EMC (3/7 wt %). The control cathodes may comprise ˜92 wt % NCM811, 4 wt % Super P and 4 wt % PVDF5130, and may be coated on 15 μm Al foil. The average loading may be 15-25 mg/cm². The 1 wt % Halloysite-containing NCM811 cathodes may comprise ˜91 wt % NCM811, 1 wt % Halloysite, 4 wt % Super P and 4 wt % PVDF5130, and may also be coated on 15 μm Al foil with a similar loading with control. The CV measurements may be in the voltage range of 2-4.3 V at a scan rate of 0.2 mV s⁻¹.

FIG. 5 shows that there is a clear oxidation peak that appears at ˜4.0 V (vs. Li/Li⁺) for the cell with Halloysite-free NCM811 cathode (control) in the initial charge. This peak for 1 wt % Halloysite-containing NCM811 cathode-based cell downshifts to 3.85 V (vs. Li/Li⁺) in the initial charge. In the following scanning cycles, the oxidation and reduction peaks for the 1 wt % Halloysite-containing NCM811 half cells are at similar positions with the control cells. FIG. 5 indicates that 1 wt % Halloysite reduces the polarization of the charging and discharging processes of NCM811 cathode half cells. This may lead to reduced interfacial impedance and enhanced cycling performance of Si-dominant anode//NCM811 cathode full cells.

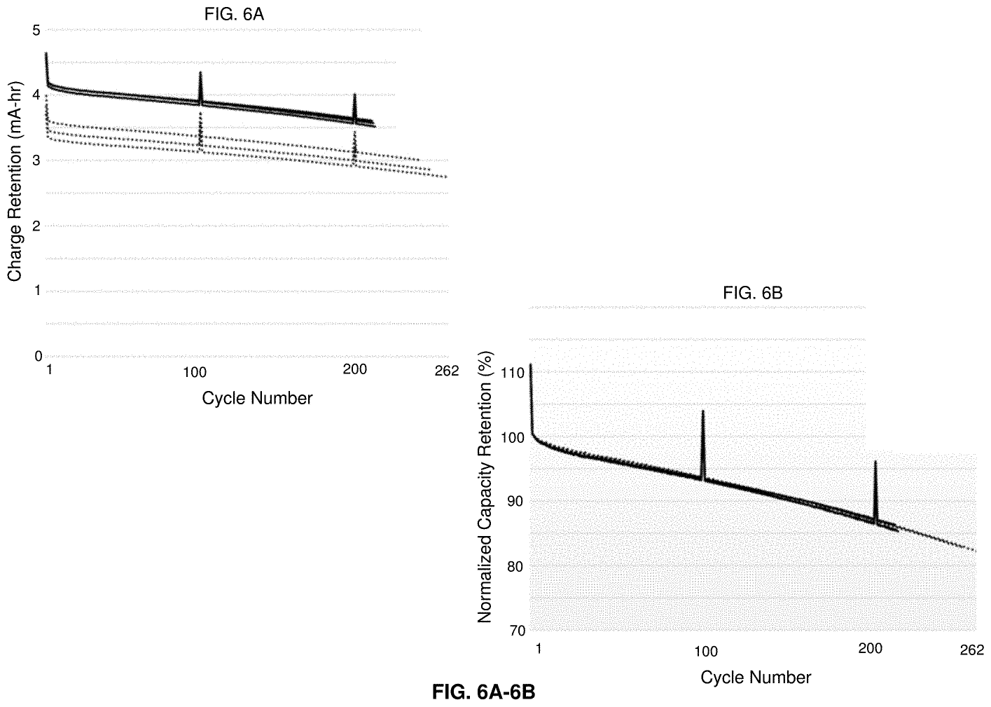

FIGS. 6A-6B illustrate capacity retention plots for cells with NCM811 vs. NCM811 cathodes with a clay additive, in accordance with an example embodiment of the disclosure.

Capacity retention is shown in FIG. 6A and normalized capacity retention is shown in FIG. 6B for Si-dominant anode//NCM811 cathode coin full cells. The dotted lines represent the NCM811 control cell and the solid lines represent 1 wt % Halloysite-containing NCM811 cell. The Si-dominant anodes comprise ˜80 wt % Si, 5 wt % graphite and 15 wt % glassy carbon (from resin) and are laminated on 15 μm Cu foil. The average loading is 2-5 mg/cm². The control cathodes comprise ˜92 wt % NCM811, 4 wt % Super P and 4 wt % PVDF5130, and are coated on 15 μm Al foil. The average loading is about 20-30 mg/cm². The 1 wt % Halloysite-containing NCM811 cathodes contain about 91 wt % NCM811, 1 wt % Halloysite, 4 wt % Super P and 4 wt % PVDF5130, and are also coated on 15 μm Al foil with a similar loading with control. The cells were tested at 25° C.

The long-term cycling programs include: (i) At the 1^{st} cycle, charge at 0.33 C to 4.2 V until 0.05 C, rest 5 minutes, discharge at 0.33 C to 3.1 V, rest 5 minutes; and (ii) from the 2^{nd} cycle, Charge at 1 C to 4.2 V until 0.05 C, rest 5 minutes, discharge at 0.5 C to 3.1 V, rest 5 minutes. But after every 100 cycles, the test conditions in the 1^{st} cycle may be repeated.

FIGS. 6A and 6B indicate the 1 wt % Halloysite-containing NCM811 cathode-based coin full cells have similar cycle performance with the control. However, the additive-containing cathode-based cells have larger discharge capacity than the control.

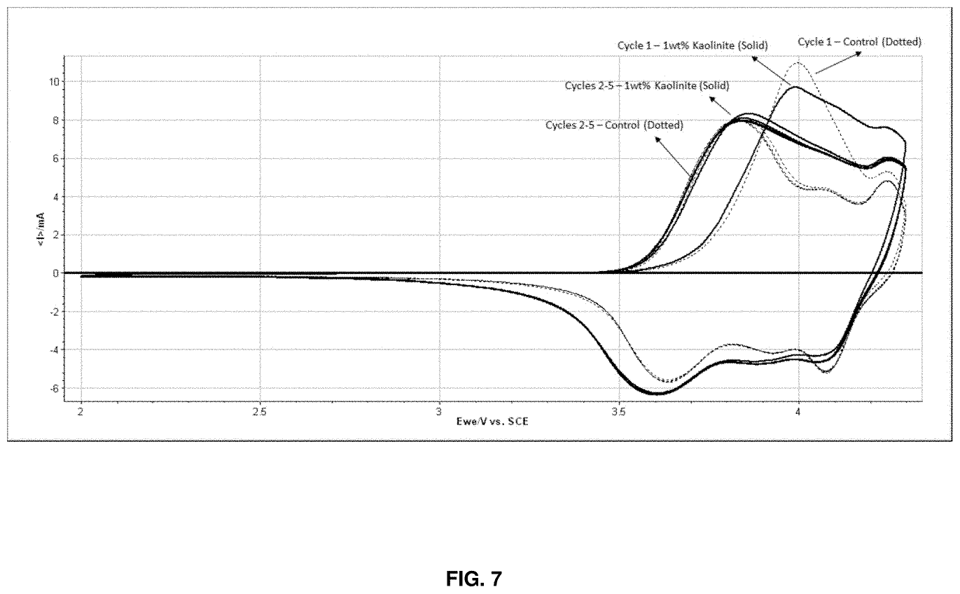

FIG. 7 illustrates cyclic voltammetry curves for control cathodes and for cathodes with clay additives, in accordance with an example embodiment of the disclosure. The plots show the effect of adding 1 wt % Kaolinite into NCM811 cathode slurry as cathode additives to prepare these clay-containing NCM811 cathodes. The Si-dominant anode//NCM811 cathode coin full cells may be tested at 1 C/0.5 C with the voltage window of 4.2V-3.1V at room temperature. The plot shows potentials of the anode and cathode with respect to a saturated calomel electrode at different cell current in milliamps.

Cyclic voltammetry (CV) curves of Si-dominant anode//NCM811 cathode full cells. The dotted lines represent an NCM811 control cathode cell and the solid lines represent a 1 wt % Kaolinite-containing NCM811 cathode cell. The electrolyte formulation may comprise 1.2 M LiPF₆ in FEC/EMC (3/7 wt %). The Si-dominant anodes may comprise about 80 wt % Si, 5 wt % graphite and 15 wt % glassy carbon (from resin) and be laminated on 15 μm Cu foil. The average loading may be 2-5 mg/cm². The control cathodes may comprise ˜92 wt % NCM811, 4 wt % Super P and 4 wt % PVDF5130, and may be coated on 15 μm Al foil. The average loading is ˜25-30 mg/cm². The 1 wt % Kaolinite-containing NCM811 cathodes contain about 91 wt % NCM811, 1 wt % Kaolinite, 4 wt % Super P and 4 wt % PVDF5130, and are also coated on 15 μm Al foil with a similar loading with control. The CV measurements may be carried out in the voltage range of 2-4.3 V at a scan rate of 0.2 mV s⁻¹.

FIG. 7 shows that there is a clear oxidation that peak appears at ˜4.0 V (vs. Li/Li⁺) for the cell with Kaolinite-free NCM811 cathode (control) in the initial charge. This peak for 1 wt % Kaolinite-containing NCM811 cathode-based cell is slightly <4.0 V (vs. Li/Li⁺) in the initial charge. In the following scanning cycles, the oxidation and reduction peaks for the 1 wt % Kaolinite-containing NCM811 half cells are at the similar positions with the control ones. FIG. 7 indicates that 1 wt % Kaolinite reduces the polarization of the charging and discharging processes of NCM811 cathode half cells. This may lead to reduced interfacial impedance and enhanced cycling performance of Si-dominant anode//NCM811 cathode full cells.

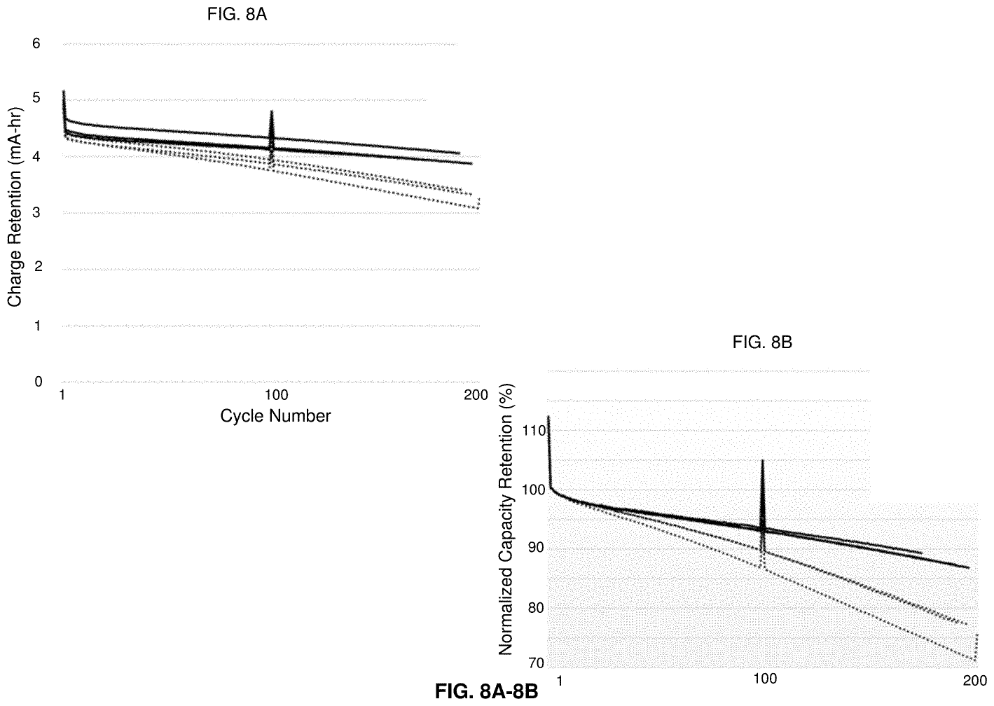

FIGS. 8A-8B illustrate capacity retention plots for cells with NCM811 vs. NCM811 cathodes with a clay additive, in accordance with an example embodiment of the disclosure. FIG. 8A illustrates capacity retention and FIG. 8B illustrates normalized capacity retention of Si-dominant anode//NCM811 cathode coin full cells. The dotted lines represent NCM811 control cathode cells and the solid lines represent 1 wt % Kaolinite-containing NCM811 cathode cells. The Si-dominant anodes comprise ˜80 wt % Si, 5 wt % graphite and 15 wt % glassy carbon (from resin) and may be laminated on 15 μm Cu foil. The average loading may be 2-5 mg/cm². The control cathodes comprise ˜92 wt % NCM811, 4 wt % Super P and 4 wt % PVDF5130, and also may be coated on 15 μm Al foil. The average loading may be 20-30 mg/cm². The 1 wt % Kaolinite-containing NCM811 cathodes contain about 91 wt % NCM811, 1 wt % Kaolinite, 4 wt % Super P and 4 wt % PVDF5130, and are also coated on 15 μm Al foil with a similar loading with control. The cells may be tested at 25° C. FIGS. 8A and 8B indicate that the 1 wt % Kaolinite-containing NCM811 cathode-based coin full cells have better cycle performance than the control with 10-15% higher capacity retention after 200 cycles.

In an example embodiment, the cathode clay additives disclosed above may be utilized to improve cycle performance for NCM cathode-based (including NCM, 433, NCM442, NCM811, NCM622, NCM532, NCM111, etc.) full cells with different Si anodes. In another example embodiment, the clay cathode additives disclosed above may be utilized to improve cycle performance for NCA cathode-based full cells with different Si anodes.

In yet another example embodiment, the cathode clay additives disclosed above may be utilized to improve cycle performance for LCO cathode-based full cells with different Si anodes, LiMn₂O₄ (LMO)-based cathodes with different Si anodes, Li-rich, xLi₂MnO₃.(1−x)LiNiₐCo_{b}Mn_{c}O₂ cathode-based full cells with different Si anodes, Ni-rich layered oxides (LiNi₁₋ₓMₓO₂, Mn=Co, Mn, and Al)-based Li-ion full cells with different Si anodes, Li-rich layered oxides (LiNi₁₊ₓM₁₋ₓO₂, Mn=Co, Mn, and Ni)-based Li-ion full cells with different Si anodes, high-voltage spinel oxides (LiNi_{0.5}Mn_{1.5}O₄) cathode Li-ion full cells with different Si anodes, and high-voltage polyanionic compounds (phosphates, sulfates, silicates, etc.) cathode-based Li-ion full cells with different Si anodes.

Furthermore, the clay additives disclosed above may be incorporated with different anodes including graphite, graphene, or combinations thereof. The electrode may comprise graphene and other types of hard/soft carbon in combination with Si and layered Si materials.

In an example embodiment of the disclosure, a method and system are described for clay minerals as cathode, anode, or separator additives in lithium-ion batteries. The battery may comprise an anode, an electrolyte, and a cathode, wherein the cathode comprises an active material and a clay additive. The active material may comprise one or more of: nickel cobalt aluminum oxide (NCA), nickel cobalt manganese oxide (NCM), NCMA, lithium iron phosphate (LFP), lithium cobalt oxide (LCO), and lithium manganese oxide (LMO), Ni-rich layered oxides LiNi₁₋ₓMₓO₂ where M=Co, Mn, or Al, Li-rich xLi₂MnO₃(1−x)LiNiₐCo_{b}Mn_{c}O₂, Li-rich layered oxides LiNi₁₊ₓM₁₋ₓO₂ where M=Co, Mn, or Ni, and spinel oxides LiNi_{0.5}Mn_{1.5}O₄.

The clay additive may comprise a Kaolin group clay mineral, where the Kaolin group clay mineral comprises Kaolinite or Halloysite. The clay additive may comprise one or more of: a Smectite group clay mineral, an Illite group clay mineral, and a Chlorite group clay material. The anode may comprise graphite and/or graphene. The anode may comprise an active material that comprises between 50% to 95% silicon. The battery may comprise a lithium ion battery. The electrolyte may comprise a liquid, solid, or gel.

As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, a battery, circuitry or a device is “operable” to perform a function whenever the battery, circuitry or device comprises the necessary hardware and code (if any is necessary) or other elements to perform the function, regardless of whether performance of the function is disabled or not enabled (e.g., by a user-configurable setting, factory trim, configuration, etc.).

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A battery comprising:
an anode, an electrolyte, and a cathode, wherein the cathode comprises an active material and a clay additive.

2. The battery according to claim 1, wherein the active material comprises one or more of: nickel cobalt aluminum oxide (NCA), nickel cobalt manganese oxide (NCM), NCMA, lithium iron phosphate (LFP), lithium cobalt oxide (LCO), and lithium manganese oxide (LMO), Ni-rich layered oxides LiNi₁₋ₓMₓO₂ where M=Co, Mn, or Al, Li-rich xLi₂MnO₃(1−x)LiNiₐCo_{b}Mn_{c}O₂, Li-rich layered oxides LiNi₁₊ₓM₁₋ₓO₂ where M=Co, Mn, or Ni, and spinel oxides LiNi_{0.5}Mn_{1.5}O₄.

3. The battery according to claim 1, wherein the clay additive comprises a Kaolin group clay mineral.

4. The battery according to claim 3, wherein the Kaolin group clay mineral comprises Kaolinite or Halloysite.

5. The battery according to claim 1, wherein the clay additive comprises a Smectite group clay mineral.

6. The battery according to claim 1, wherein the clay additive comprises an Illite group clay mineral or a chlorite group clay material.

7. The battery according to claim 1, wherein the anode comprises graphite and/or graphene.

8. The battery according to claim 1, wherein the anode comprises an active material that comprises between 50% to 95% silicon.

9. The battery according to claim 1, wherein the battery comprises a lithium ion battery.

10. The battery according to claim 1, wherein the electrolyte comprises a liquid, solid, or gel.

11. A method of forming a battery, the method comprising:
forming a battery comprising an anode, an electrolyte, and a cathode, wherein the cathode comprises an active material and a clay additive.

12. The method according to claim 11, wherein the active material comprises one or more of: nickel cobalt aluminum oxide (NCA), nickel cobalt manganese oxide (NCM), NCMA, lithium iron phosphate (LFP), lithium cobalt oxide (LCO), and lithium manganese oxide (LMO), Ni-rich layered oxides LiNi₁₋ₓMₓO₂ where M=Co, Mn, or Al, Li-rich xLi₂MnO₃(1−x)LiNiₐCo_{b}Mn_{c}O₂, Li-rich layered oxides LiNi₁₊ₓM₁₋ₓO₂ where M=Co, Mn, or Ni, and spinel oxides LiNi_{0.5}Mn_{1.5}O₄.

13. The method according to claim 11, wherein the clay additive comprises a Kaolin group clay mineral.

14. The method according to claim 13, wherein the Kaolin group clay mineral comprises Kaolinite or Halloysite.

15. The method according to claim 11, wherein the clay additive comprises a Smectite group clay mineral.

16. The method according to claim 11, wherein the clay additive comprises an Illite group clay mineral or a chlorite group clay material.

17. The method according to claim 11, wherein the anode comprises graphite and/or graphene.

18. The method according to claim 11, wherein the anode comprises an active material that comprises between 50% to 95% silicon.

19. The method according to claim 11, wherein the battery comprises a lithium ion battery and the electrolyte comprises a liquid, solid, or gel.

20. A battery, the battery comprising:
a battery comprising a silicon-dominant anode, an electrolyte, and a cathode, wherein the cathode comprises an active material and a clay additive, the clay additive comprising one or more of: a Kaolin group clay mineral, a Smectite group clay mineral, an Illite group clay mineral, and a Chlorite group clay material.
